(19) United States
(12) Patent Application Publication
(10) Pub. No.: US 2024/0307836 A1
(43) Pub. Date: Sep. 19, 2024

(54) LIQUID PUMP

(71) Applicant: FLUID-O-TECH S.R.L., Corsico (MI) (IT)

(72) Inventors: Diego ANDREIS, Corsico (MI) (IT); Francesco BUTERA, Corsico (MI) (IT); Filippo Maria DAL BORGO, Roma (IT)

(21) Appl. No.: 18/605,415

(22) Filed: Mar. 14, 2024

(30) Foreign Application Priority Data
Mar. 16, 2023 (IT) 102023000004992

(51) Int. Cl. B01F 25/62; A01J 11/16; B01F 101/06; F04C 2/08

(52) U.S. Cl. CPC B01F 25/62; A01J 11/16; F04C 2/084; B01F 2101/06; B01F 2215/0431; F04C 2240/30

(57) ABSTRACT

The present invention relates to an improved liquid pump (1) comprising at least one rotating pumping member (2, 3) and a drive shaft (4) rigidly constrained to said at least one rotating pumping member (2) and configured to drive said at least one rotating pumping member (2) into rotation, said at least one rotating pumping member (2, 3) being completely housed in a pumping chamber (6) formed within a pump casing (7), said drive shaft (4) being partially housed within said pump casing (7), between said drive shaft (4) and said pump casing (7) there being provided at least one liquid-tight seal (8) for preventing leakage of said liquid along said drive shaft (4), said pump (1) comprising a suction duct (9) in liquid communication with said pumping chamber (6) and a delivery duct (11) in liquid communication with said pumping chamber (6).

According to the invention, inside said pump casing (7) a flushing chamber (13) is formed in liquid communication with said suction duct (9) or with said delivery duct (11), said drive shaft (4) passing through said flushing chamber (13), said at least one seal (8) having at least one portion (80) facing said flushing chamber (13) so that the flow of said liquid running inside said flushing chamber (13) laps said portion (80) of said seal (8).

### FIELD OF THE INVENTION

The present invention relates to an improved liquid pump, particularly for food-grade liquids, such as milk, or biological liquids in general.

The present invention constitutes an improvement aimed at facilitating the cleaning of ducts and chambers within the pump itself, as well as improving its hygiene, particularly in applications in the food sector and the medical sector.

### STATE OF THE ART

As is well known, pumps for pumping liquids have at least one rotating pumping member comprising a respective shaft, driven by a motor. The rotating pumping member is housed inside the pump casing, in a special pump chamber, while the drive shaft passes through the pump casing to connect to the motor outside the pump casing. The at least one rotating member may be, for example, an impeller, in the case of centrifugal pumps, or a pair of gears, in the case of gear pumps (internal or external). In any case, to prevent leakage of the pumped liquid along the drive shaft, at least one seal is generally fitted onto the drive shaft itself, inside the pump casing.

However, these pumps of the known type have certain drawbacks, including the fact that there are often dead areas between suction and delivery, where there is little or no flow of the pumped liquid, where the stagnation thereof can thus occur. In particular, the configuration of pumps of the known type is generally such that the aforementioned dead areas are created in the vicinity of the seals fitted onto the drive shaft. In the case of applications in the food and/or medical sector, where the pumped liquid is a food-grade or biological liquid, stagnation phenomena are not only undesirable, but also seriously harmful. In fact, the stagnation of food-grade or biological liquids not only leads to a deterioration in pump and/or seal performance, but also poses serious hygiene and bacterial proliferation risks.

Today, pump flushing cycles are known to be performed, particularly in the food and medical sectors. However, precisely because of the configuration of known pumps, the flushing liquid also tends to stagnate in the dead areas, and in particular near the seals fitted onto the drive shaft. Consequently, the cleaning of pumps of the known type by means of flushing cycles does not take place efficiently and still does not guarantee the proper cleaning of the dead areas.

### SUMMARY OF THE INVENTION

In light of the above, it is the scope of the present invention to realise an improved liquid pump that exceeds the limits of the prior art and is easily and efficiently cleaned.

Within this scope, it is the object of the present invention to realise an improved liquid pump that guarantees high levels of hygiene, particularly in the case of applications in the food and medical sector.

Another object of the present invention is to guarantee proper operating maintenance of the seals, so that the sealing performance of the liquid remains unchanged over time.

A further object of the invention consists of making an improved liquid pump that is capable of providing the broadest guarantees of reliability and safety when used.

Yet another object of the invention is to provide a pump that is easy to make and economically competitive in its operation and maintenance.

The task disclosed above, and also the objects mentioned and others which are more apparent below, are achieved by an improved liquid pump according to claim 1.

Other features are provided in the dependent claims.

### LIST OF FIGURES

Further characteristics and advantages of the present invention will become more apparent from the exemplary but non-limiting description of three preferred embodiments of the present invention illustrated with the aid of the attached drawings in which:

FIG. 1 is a plan view from above of a first embodiment of an improved liquid pump according to the invention;

FIG. 2 shows the liquid pump in FIG. 1, with the pump cover removed;

FIG. 3 is a first cross-sectional view of the liquid pump in FIG. 1;

FIG. 4 is a second cross-sectional view of the liquid pump in FIG. 1;

FIG. 5 is a plan view from above of a second embodiment of an improved liquid pump according to the invention;

FIG. 6 shows the liquid pump in FIG. 5, with the pump cover removed;

FIG. 7 is a first cross-sectional view of the liquid pump in FIG. 5;

FIG. 8 is a second cross-sectional view of the liquid pump in FIG. 5;

FIG. 9 is a plan view from above of a third embodiment of an improved liquid pump according to the invention;

FIG. 10 shows the liquid pump in FIG. 9, with the pump cover removed;

FIG. 11 is a first cross-sectional view of the liquid pump in FIG. 9;

FIG. 12 is a second cross-sectional view of the liquid pump in FIG. 9.

### DETAILED DESCRIPTION OF THE INVENTION

With particular reference to the figures, the improved liquid pump, referred to overall by reference numeral 1, comprises at least one rotating pumping member 2, 3 and a drive shaft 4 rigidly constrained to said at least one rotating pumping member 2 and configured to drive said at least one rotating pumping member 2 into rotation. The at least one rotating pumping member 2, 3 is completely housed in a pumping chamber 6 formed inside the pump casing 7. The drive shaft 4 is partially housed inside the pump casing 7. At least one liquid-tight seal 8 is arranged between the drive shaft 4 and the pump casing 7, which prevents the liquid from leaking along the drive shaft 4, itself, to the outside of the pump casing 7. The pump 1 also comprises a suction duct 9 in liquid communication with pumping chamber 6, and a delivery duct 11 in liquid communication with the pumping chamber 6.

According to the invention, a flushing chamber 13 in liquid communication with the suction duct 9 or delivery duct 11 is formed inside the pump casing 7. The drive shaft 4 passes through the flushing chamber 13 and the at least one seal 8 has at least one portion 80 facing the flushing chamber 13 so that the flow of liquid running inside the flushing chamber 13 laps the portion 80 of the seal 8.

In this way, when the pump 1 is operating, the portion 80 of seal 8 facing the flushing chamber 13 is constantly hit by the flow of pumped liquid. Consequently, the sealing area of the drive shaft 4 is not a so-called dead area, where the liquid tends to stagnate, but is an area characterised by a constant presence of liquid flow.

The pump casing 7 preferably comprises a base casing 75, and a cover 76. As illustrated in the accompanying figures, the pumping chamber 6 is located inside the base casing 75 and is closed at the top by the cover 76. The flushing chamber 13, on the other hand, is housed in the base casing 75.

Preferably, the suction duct 9 (or the delivery duct 11) which is in direct liquid communication with the flushing chamber 13 has a main extension direction 90 (or 110). The flushing chamber 13 is arranged inside the pump casing 7, aligned with said main extension direction 90 (or 110) of the suction duct 9 (or the delivery duct 11). In this way, the flow of pumped liquid hits and flows through the flushing chamber 13 itself along a preferential main flow direction.

As illustrated in the accompanying figures, the flushing chamber 13 is defined by a volume comprised between an upper base and a lower base. The main extension direction 90 (or 110) of the suction duct 9 (or of the delivery duct 11) preferably lies in a plane interposed between the upper base and lower base of the flushing chamber 13 volume. More preferably, the upper base, the lower base and the plane in which the main extension direction 90 (or 110) of the suction duct 9 (or the delivery duct 11) lies are parallel to each other.

The improved liquid pump 1 may be a positive displacement pump or a centrifugal pump.

For example, the pump 1 may be a positive displacement pump with internal or external gears, or a positive displacement pump with lobes, or even a positive displacement pump with vanes.

In all of the above cases, the pump 1 comprises at least one rotating pumping member 2, 3 driven by means of a respective drive shaft 4. In the case of a positive displacement pump with gears or lobes, there is a driven rotating pumping member 2 and an idle rotating pumping member 3.

In the case of a centrifugal pump, the rotating pumping member may comprise an impeller, or a turbine, fitted onto the drive shaft, or made as one piece with the drive shaft.

Preferably, as illustrated in the examples of the three embodiments of an improved liquid pump 1, the pump 1 is a positive displacement pump with external gears, comprising a pair of rotating pumping members 2, 3 consisting of a pair of toothed wheels 21, 31. A first driven toothed wheel 21 is fitted onto or made as a single piece with the drive shaft 4, while a second idle toothed wheel 41 is driven in rotation by the first toothed wheel 21, and is fitted onto or made as a single piece with an idle rotation shaft 32, preferably fully housed within the pump casing 7.

Preferably the seal 8 is a lip seal. Alternatively, the seal 8 may also be an O-ring type seal.

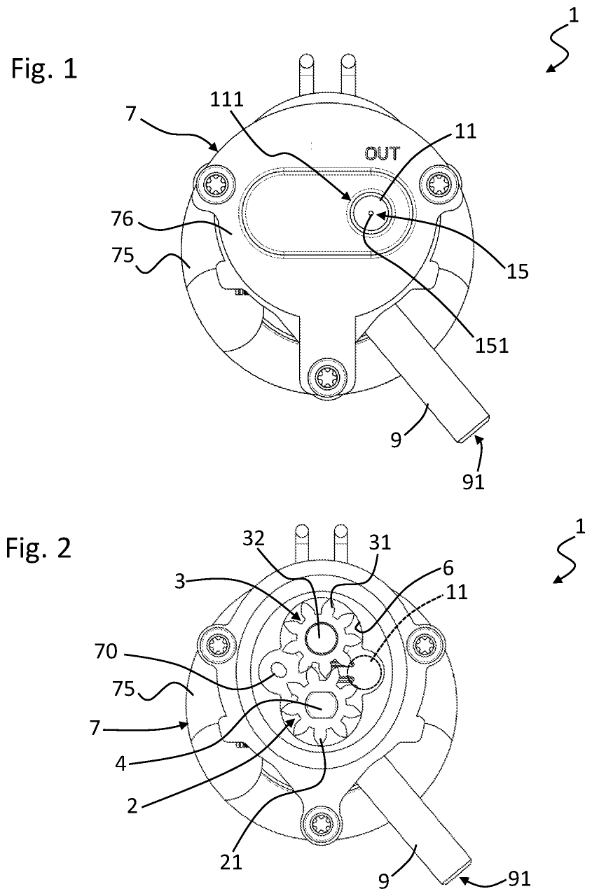

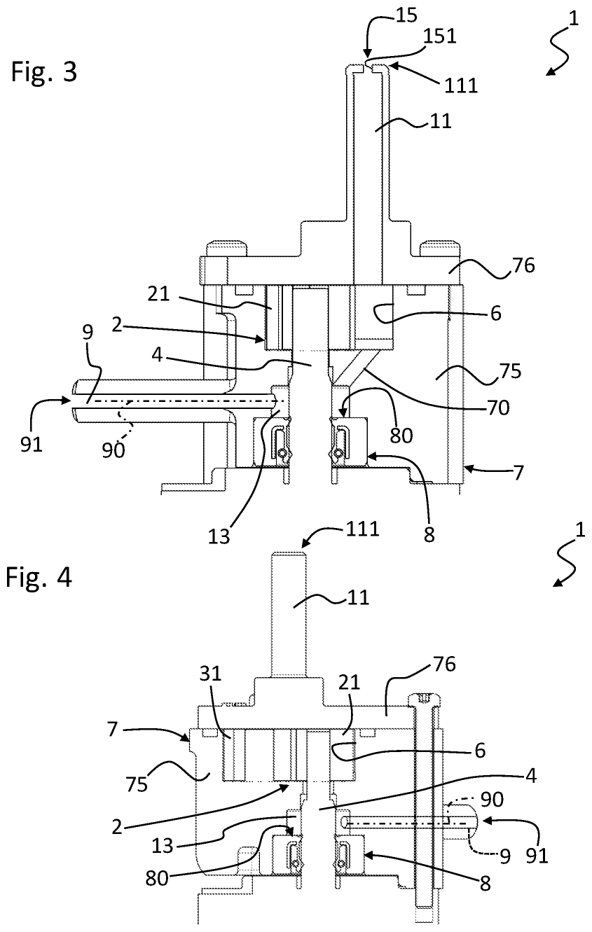

With reference to the first embodiment of the pump 1, illustrated in FIGS. 1 to 4, the flushing chamber 13 is arranged upstream of the pumping chamber 6, in direct liquid communication with the suction duct 9.

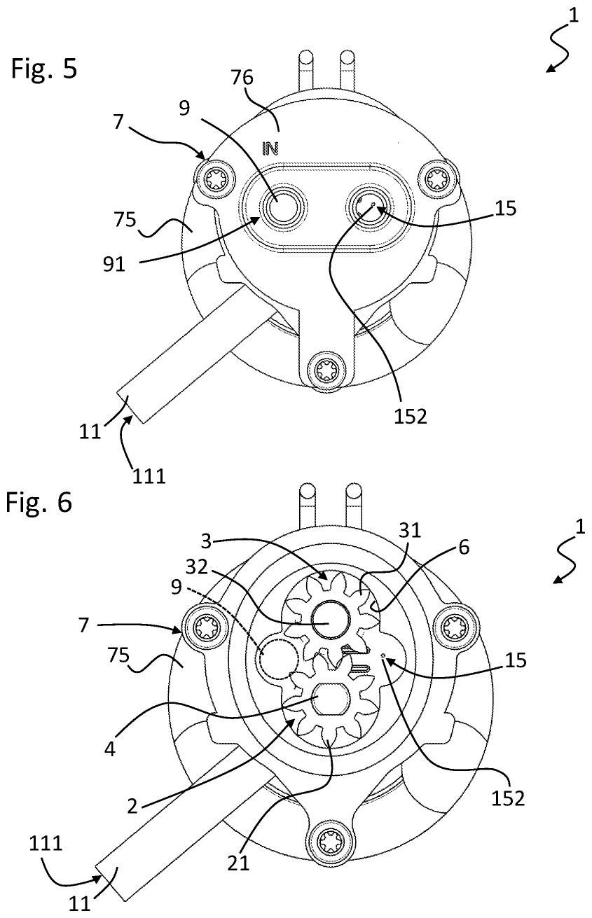

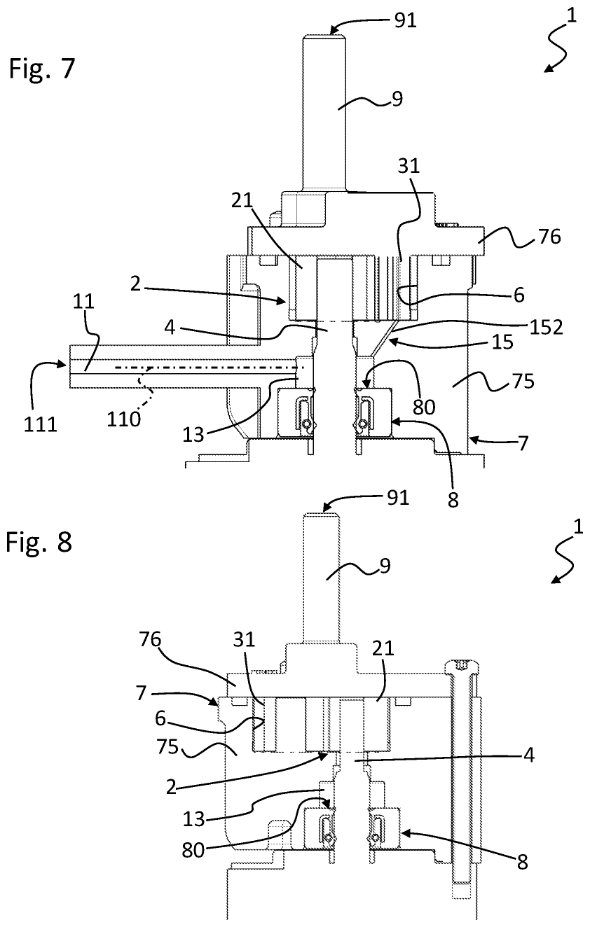

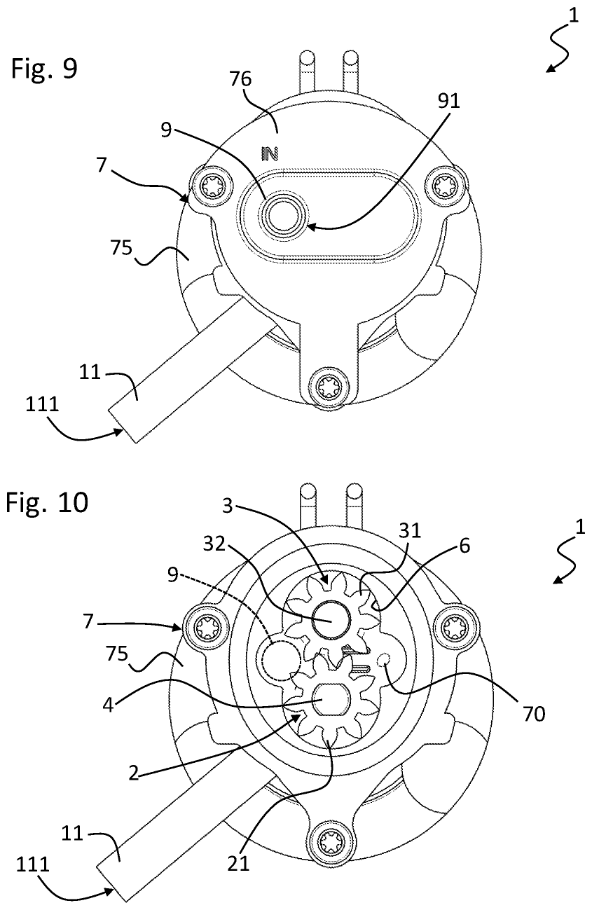

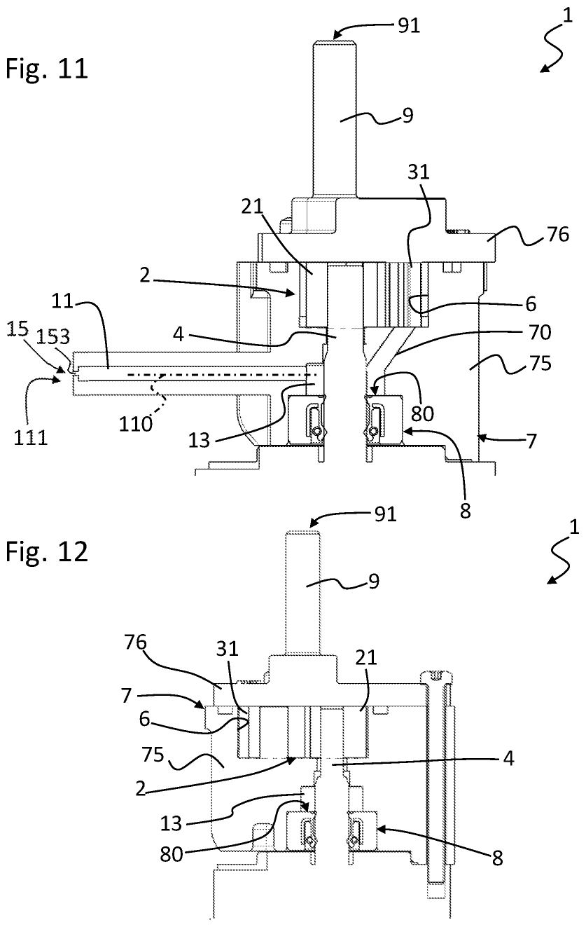

With reference to the second embodiment of the pump 1, illustrated in FIGS. 5 to 8, and also with reference to the third embodiment of the pump 1, illustrated in FIGS. 9 to 12, the flushing chamber 13 is arranged downstream of the pumping chamber 6, in direct liquid communication with the delivery duct 11.

Preferably, the improved liquid pump 1 comprises a suction mouth 91, in liquid communication with the suction duct 9, and a delivery mouth 111, in liquid communication with the delivery duct 11. In at least one point along the liquid path within the pump 1, between the suction mouth 91 and the delivery mouth 111, the pump 1 comprises at least one restriction 15 configured to generate an emulsion of the liquid passing through said at least one restriction 15.

Advantageously, the improved liquid pump 1 is a pump for emulsifying milk, and this restriction 15 is configured to generate a milk emulsion.

Preferably, as illustrated in FIGS. 1 to 4 with reference to the first embodiment of the pump 1, and in FIGS. 9 to 12 with reference to the third embodiment, the restriction 15 consists of an emulsion orifice 151, 153 formed at the delivery mouth 111.

Preferably the emulsion orifice 151, 153 has a diameter less than 1.5 mm, and more preferably less than 1.0 mm. For example, the diameter of the emulsion orifice 151, 153 may be about 0.7 mm.

Advantageously, in the case of the first embodiment of the pump 1, the flushing chamber 13, being located upstream of the pumping chamber 6, on the suction side, is traversed by low-pressure liquid and therefore the seal 8 is a low-pressure seal.

In the case of the third embodiment of the pump 1, however, the flushing chamber 13 is located downstream of the pumping chamber 6, on the delivery side, and upstream of the restriction 15. The flushing chamber 13 is therefore traversed by high-pressure liquid and consequently the seal 8 is a high-pressure seal.

Alternatively, as illustrated in FIGS. 5 to 8 with reference to the second embodiment of the pump 1, the restriction 15 consists of a duct with a reduced cross-section 152 formed within the pump casing 7 between the flushing chamber 13 and the pumping chamber 6.

Preferably the reduced cross-section duct 152 has a diameter of less than 1.5 mm, and more preferably less than 1.0 mm. For example, the diameter of the reduced cross-section duct 152 may be about 0.7 mm.

Preferably the flushing chamber 13 is arranged downstream of the pumping chamber 6 but also downstream of the restriction 15. In this case, therefore, the flushing chamber 13 is traversed by low-pressure liquid and consequently the seal 8 is a low-pressure seal.

In particular, in the case of the second embodiment of the pump 1, although the flushing chamber 13 is located downstream of the pumping chamber 6, i.e. on the delivery side, but also being located downstream of the reduced cross-section duct 152, it is traversed by low-pressure liquid and therefore the seal 8 may be a low-pressure seal.

As illustrated in the accompanying figures, the pumping chamber 6 and the flushing chamber 13 are in liquid communication with each other via a duct 70, 152 formed inside the pump casing 7.

In the course of normal operation of the improved liquid pump 1, the liquid being pumped through the flushing chamber 13 laps the portion 80 of the seal 8 facing this flushing chamber 13 in a constant manner and with an adequate flow rate, thus preventing the formation of liquid stagnation zones at the seal 8 itself. Therefore, even during normal operation of the pump 1, the seal 8 is constantly rinsed by the liquid itself being pumped, which prevents the deposit and formation of unwanted and harmful residues.

In addition, as the pump 1 is in any case subjected from time to time to washing and/or sterilisation cycles with special washing liquids, such as liquid detergents, the configuration of the washing chamber 13 is such that the sealing area at the seal 8 is washed and cleaned very effectively by this washing liquid, as there are no dead or stagnation areas in the pump 1 which even the flushing liquid struggles to reach, or which it reaches at minimum flow rates, which are not sufficient to guarantee proper cleaning.

The improved liquid pump 1 can also advantageously be used to emulsify milk, thanks to the presence of the emulsion restriction 15.

In practice, it has been found that the improved liquid pump according to the present invention fulfils the task as well as the intended objects as it prevents the stagnation of liquid inside and is therefore easily and effectively cleaned.

Another advantage of the improved liquid pump, according to the invention, is that it ensures high levels of hygiene, particularly for applications in the food and medical sectors.

A further advantage of the pump according to the invention is that it can also be used in the food industry to emulsify milk. As is well known, milk is a highly perishable biological liquid, very prone to bacterial proliferation. The pump according to the invention therefore achieves the dual advantage of being able to process milk, emulsifying it with high efficiency, while also ensuring very high levels of hygiene and cleanliness.

The improved liquid pump thus conceived can undergo several modifications and variants all within the scope of the inventive concept.

Furthermore, all the details can be replaced by other technically equivalent elements.

In practice, any materials can be used according to requirements, as long as they are compatible with the specific use, the dimensions and the contingent shapes.

1. An improved liquid pump comprising at least one rotating pumping member and a drive shaft rigidly constrained to said at least one rotating pumping member and configured to drive said at least one rotating pumping member into rotation, said at least one rotating pumping member being completely housed in a pumping chamber formed within a pump casing, said drive shaft being partially housed within said pump casing, between said drive shaft and said pump casing there being provided at least one liquid-tight seal for preventing leakage of said liquid along said drive shaft, said pump comprising a suction duct in liquid communication with said pumping chamber and a delivery duct in liquid communication with said pumping chamber, characterised in that inside said pump casing a flushing chamber is formed in liquid communication with said suction duct or with said delivery duct, said drive shaft passing through said flushing chamber, said at least one seal having at least one portion facing said flushing chamber so that the flow of said liquid running inside said flushing chamber laps said portion of said seal.

2. The pump according to the claim 1, wherein said suction duct, or said delivery duct, which is in direct liquid communication with said flushing chamber, has a main extension direction, said flushing chamber being arranged within said pump casing aligned with said main extension direction of said suction duct or of said delivery duct.

3. The pump according to claim 1, characterised in that it is a gear a pump, wherein said at least one rotating pumping member comprises a first toothed wheel rigidly constrained to said drive shaft and a second toothed wheel geared to said first toothed wheel and adapted to be driven into rotation by said first toothed wheel.

4. The pump according to claim 1, wherein said flushing chamber is arranged upstream of said pumping chamber, in direct liquid communication with said suction duct.

5. The pump according to claim 1, wherein said flushing chamber is arranged downstream of said pumping chamber, in direct liquid communication with said delivery duct.

6. The pump according to claim 1, comprising a suction mouth, in liquid communication with said suction duct, and a delivery mouth, in liquid communication with said delivery duct, in at least one point along the liquid path within said pump, between said suction mouth and said delivery mouth, said pump comprising at least one restriction configured to generate an emulsion of the liquid passing through said at least one restriction.

7. The pump according to claim 6, characterised in that it is a pump for emulsifying milk and in that said at least one restriction is configured to generate a milk emulsion.

8. The pump, according to claim 6, wherein said at least one restriction consists of an emulsion orifice formed at said delivery mouth.

9. The pump, according to claim 6 wherein said at least one restriction consists of a reduced cross-section duct formed within said pump casing between said flushing chamber and said pumping chamber.

10. The pump according to claim 8 wherein said emulsion orifice has a diameter of less than 1.5 mm.

11. The pump according to claim 10 wherein said emulsion orifice has a diameter of less than 1.0 mm.

12. The pump according to claim 9 wherein said reduced cross-section duct has a diameter of less than 1.5 mm.

13. The pump according to claim 12 wherein said reduced cross-section duct has a diameter of less than 1.0 mm.

14. The pump according to claim 6, wherein said flushing chamber is arranged downstream of said pumping chamber and downstream of said restriction, said seal being a low-pressure seal.

15. The Pump according to claim 1, wherein said pumping chamber and said flushing chamber are in liquid communication with each other by means of a duct formed within said pump casing.

16. A pump for emulsifying milk comprising at least one rotating pumping member and a drive shaft rigidly constrained to said at least one rotating pumping member and configured to drive said at least one rotating pumping member into rotation, said at least one rotating pumping member being completely housed in a pumping chamber formed within a pump casing, said drive shaft being partially housed within said pump casing, between said drive shaft and said pump casing there being provided at least one liquid-tight seal for preventing leakage of said liquid along said drive shaft, said pump comprising a suction duct in liquid communication with said pumping chamber and a delivery duct in liquid communication with said pumping chamber, inside said pump casing a flushing chamber is formed in liquid communication with said suction duct or with said delivery duct, said drive shaft passing through said flushing chamber, said at least one seal having at least one portion facing said flushing chamber so that the flow of said liquid running inside said flushing chamber laps said portion of said seal, said pump comprising a suction mouth, in liquid communication with said suction duct, and a delivery mouth, in liquid communication with said delivery duct, in at least one point along the liquid path within said pump, between said suction mouth and said delivery mouth, said pump comprising at least one restriction configured to generate an emulsion of the liquid passing through said at least one restriction, said liquid being milk, and said at least one restriction being configured to generate a milk emulsion.
